(19) United States
(12) Patent Application Publication
(10) Pub. No.: US 2013/0278927 A1
(43) Pub. Date: Oct. 24, 2013

(54) Raised Vial Stopper Detection System

(71) Applicants: Mitchell R. Johnson, Simi Valley, CA (US); David L. Rojas, Simi Valley, CA (US)

(72) Inventors: Mitchell R. Johnson, Simi Valley, CA (US); David L. Rojas, Simi Valley, CA (US)

(73) Assignee: Make-All Corporation, Simi Valley, CA (US)

(21) Appl. No.: 13/882,980

(22) PCT Filed: Nov. 1, 2011
(86) PCT No.: PCT/US2011/058853

§ 371 Date: Jul. 12, 2013

Related U.S. Application Data
(60) Provisional application No. 61/409,009, filed on Nov. 1, 2010.

(51) Int. Cl. G01N 21/90

(52) U.S. Cl. CPC G01N 21/9054
USPC 356/240.1; 356/237.1

(57) ABSTRACT

A system for inspecting the closures of packaged products employing lasers and receivers to scan multiple sides of a package thereby measuring and determining a pass/fail status of a parameter of a package closure. In one embodiment, the system employs two lasers each emitting a beam that crosses one another, as well as a product inspection path.

### RELATED APPLICATIONS

This application claims priority to U.S. Provisional Application Ser. No. 61/409,009 filed Nov. 1, 2010 entitled Raised Vial Stopper Detection System, which is hereby incorporated herein by reference in its entirety.

### FIELD OF THE INVENTION

The present invention relates to product packaging and, more particularly relates to the inspection of packaging closures.

### BACKGROUND OF THE INVENTION

In most industries, the quality and preservation of packaged goods depend to a large extent upon the quality of the packaging of the goods. One important aspect of package quality is the effectiveness of the closure at sealing the product in the container and protecting it from outside elements. An improperly set closure may allow air and other elements into the container and in contact with the product thereby resulting in product contamination, spoilage and/or a reduction in quality or freshness or other adverse effects. Closure set may also affect other aspects of product packaging, such as the application of a safety seal around the closure, or packaging and product stacking.

Today, automation processes are commonplace for filling containers and packages with a product and securing closures on the containers and packages. Modern equipment can fill containers and apply closures at rates from 100 to 2000 containers per minute and beyond. After a product, such as a solid, liquid, or gas, is dispensed into a container and a closure is applied to the opening of the container and secured. Safety seals and/or tamper-proof devices may be applied to the container and/or closure before or after the closure is secured to the container.

One example of such an automated process is the packaging and closure of pharmaceuticals and other medical related substances into vials. Medical vials are provided in a range of shapes and can be, for example, from 1 to 100 milliliters in volume. During the packaging process, a product is automatically dispersed into an empty, sterile vial; a stopper is inserted into the opening of the vial; and the stopper is secured to the vial by capping the vial and stopper with, for example, an aluminum cap or covering. The filling of the vial and the placement of the stopper in the vial are typically performed in a more highly controlled environment than the environment, such as an aseptic room, in which the stopper and vial are capped. For obvious health reasons, a significant concern within the medical industry is the sterility and maintained sterility of packaged pharmaceuticals and other medical related substances.

Of growing concern is the potential contamination of packaged medical substances that may result from stoppers that are not properly set into the vial and the subsequent improper capping and contamination of the product during the capping step. FIG. 1A shows an example of a stopper 12 that is properly set into a vial 14. FIGS. 1B and 1C show examples of stoppers 12 that are not properly set within vials 14. Of particular note is that the stopper 12 shown in FIG. 1A is inserted into the vial 14 such that there is little or no gap 16 between a lower surface 22 of flange 18 of the stopper 12 and the rim 20 of the vial 14 as compared to the gaps 16 shown in FIGS. 1B and 1C. The vial 14 and stopper 12 shown in FIG. 1B have a significant, substantially uniform gap 16 and the vial 14 and stopper 12 shown in FIG. 1C have a significant, cocked or non-uniform gap 16.

In an attempt to increase product packaging quality and safety, devices have been developed that employ vision-based techniques to monitor certain aspects of the packaged product, such as the height of a lid or cap attached to a product container; the uniformity of the lid or cap upon a container; and, in the case of medical vials, the gap between a lower surface of a stopper flange and the rim of the vial. However, vision-based systems have proved problematic for a number of reasons. First, the varying depth of field as the vial passes in front of the camera affects inspection tolerances. Second, fluctuating lighting sources affect image quality thereby leading to less repeatable data. Third, the need to image around the diameter of the vial-stopper interface requires a complex system employing multiple cameras and/or a complex imaging system. Finally, changes in vial sizes, profiles, color, and stopper shapes require alterations to the vision-based system thereby complicating set-up and operation of the system.

Examples of such vision-based closure inspection systems are described in U.S. Pat. No. 6,654,117 to Reading and U.S. Pat. No. 6,473,170 to Schafer which are herein incorporated by reference.

What is needed in the art is a closure monitoring system that is simple to operate and set-up; that can easily be adjusted for variation in vial shape and size; as well as stopper shape and size; that easily detects packages or vials with missing closures or stoppers; and that has increased accuracy and throughput.

### OBJECTS AND SUMMARY OF THE INVENTION

The object of the present invention is to provide a package closure monitoring system and related method that addresses the above described problems with the current art. The present invention achieves this objective by providing an inspection system for inspecting the closures of packaged products that employs one or more lasers and associated receivers to scan multiple sides of a package as a package is transposed along a product inspection path. Accordingly, the system of the present invention measures and determines the pass/fail status for certain parameters of a package closure.

In one embodiment, the system employs two lasers each emitting a beam that crossed one another, as well as a product inspection path. The lasers are triggered by an encoder associated with the product inspection path. The encoder is, in turn, associated with a sensor that signals the encoder when a packaged product intended for inspection has been sensed.

### BRIEF DESCRIPTION OF THE DRAWINGS

These and other aspects, features and advantages of which embodiments of the invention are capable of will be apparent and elucidated from the following description of embodiments of the present invention, reference being made to the accompanying drawings, in which

FIGS. 1A-1C are side elevation views of vials with stoppers inserted therein.

FIG. 2 is a plan view of a portion of a detection system according to an embodiment of the present invention.

FIG. 3 is a plan view of a portion of a detection system according to an embodiment of the present invention.

FIG. 4 is a side elevation view of a portion of a detection system according to an embodiment of the present invention.

FIGS. 5A and 5B are plan views of a portion of a detection system according to an embodiment of the present invention.

FIGS. 6A and 6B are plan views of a portion of a detection system according to an embodiment of the present invention.

FIGS. 7A-7C are views of a portion of a detection system according to an embodiment of the present invention.

FIG. 8 is a diagram of the relationship between various components of a detection system according to an embodiment of the present invention.

FIG. 9 is a flow diagram of the logic path of a detection system according to an embodiment of the present invention.

### DESCRIPTION OF EMBODIMENTS

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

It is noted that while the following description describes the present invention with respect to the invention's application to the detection of stoppers that are improperly placed or set into vials, this particular application of the invention is described only to facilitate comprehension of the present invention and is not intended to be limiting. One having ordinary skill in the art will understand that the present invention can be used for the monitoring and detection of closures for a multitude of container types.

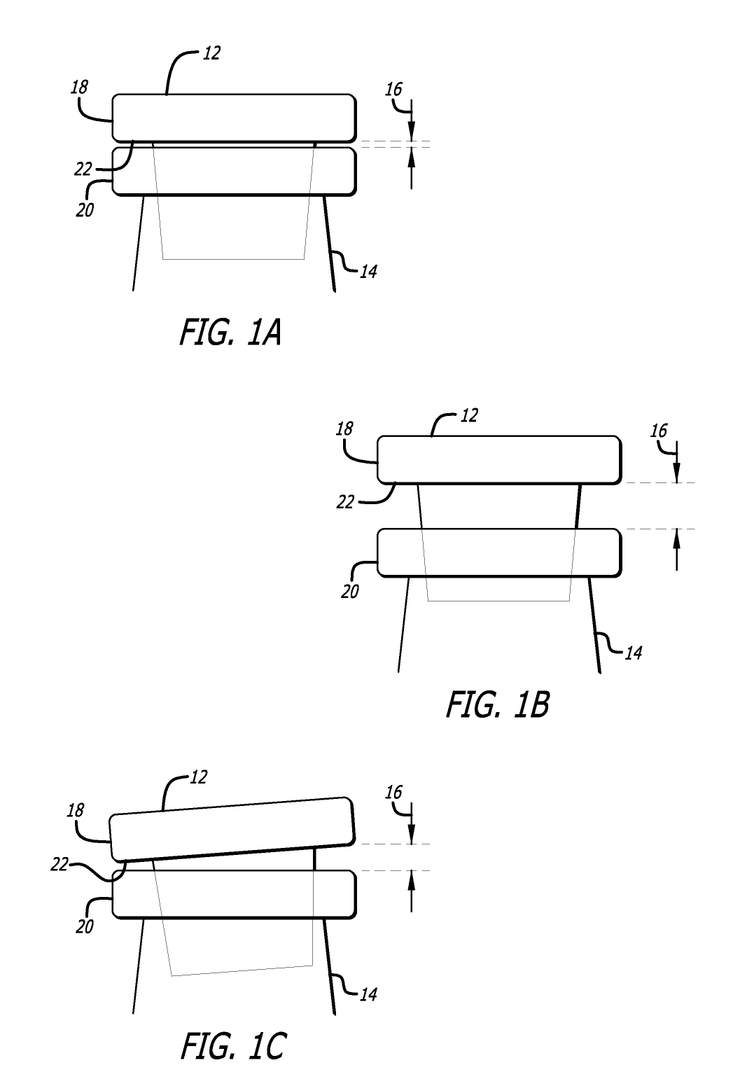

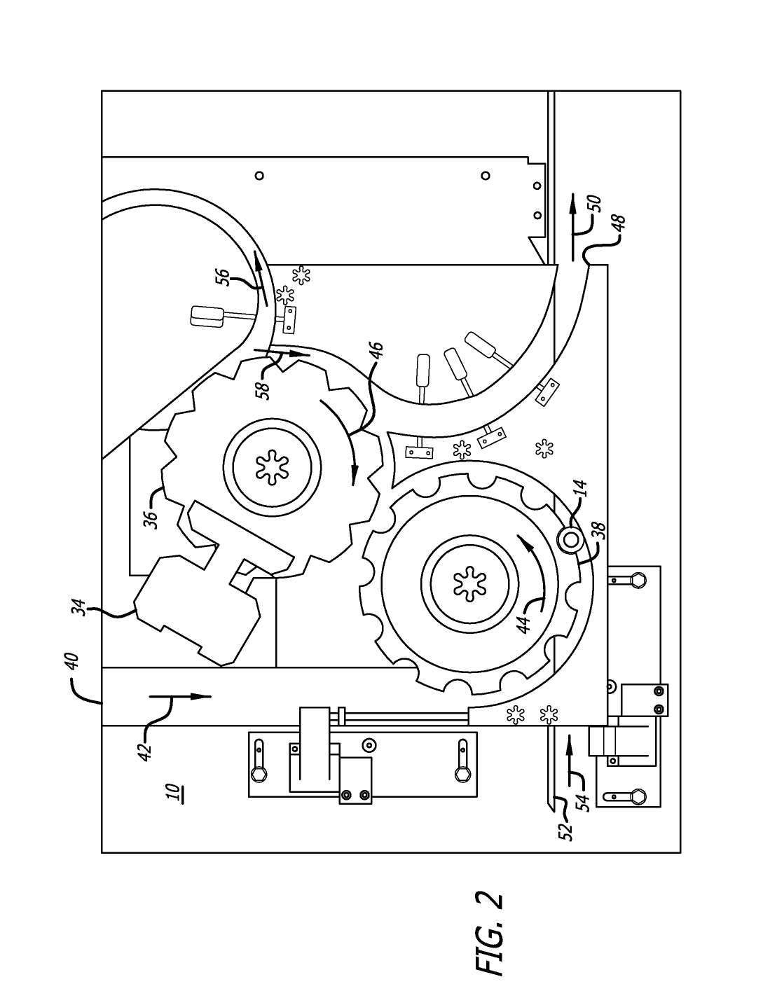

Broadly speaking, and with reference to FIGS. 1A-1C and 2, a detection system 10 measures the gap 16 between the lower surface 22 of the flange 18 of the stopper 12 and the rim 20 of the vial 14 by employing sensors and measurement devices arranged such that the presence of the vial 14 and the stopper 12 inserted into the vial 14 are detected, the stopper gap 16 is measured, and a gap pass/fail determination is made. More particularly, the system 10 employs one or more pairs of lasers and associated receivers that scan a portion of the vial 14 and stopper 12 as the vial 14 and stopper 12 are displaced across one or more light paths spanning between the one of more pairs of lasers and receivers.

As shown in FIG. 2, in one embodiment of the present invention a detection system 10 employs a first in-feed 40 in which vial 14 is displaced in a direction indicated by arrow 42; a star wheel 38 that rotates in a direction indicated by the arrow 44; an inspection star wheel 36 that rotates in a direction indicated by the arrow 46; an inspection station 34 below which or through which the inspection star wheel 36 rotates; and an out-feed 48 through which vial 14 exits the system 10 in a direction indicated by arrow 50. It will be noted that the various directions indicated by arrows 42, 44, 46, and 50 are broadly regarded as a product inspection path.

In operation, the vial 14 enters the system 10 through the in-feed 40 that, for example, leads from a lyophilyzation autoloader. The vial 14 is displaced in the direction of arrow 42 such that the vial 14 is engaged by the star wheel 38. In certain embodiments, the vial 14 may enter the system 10 through an alternative or second in-feed 52 that, for example, leads from a liquid filler and is displaced in the direction of arrow 54 towards the star wheel 38. Once the vial 14 is engaged by the star wheel 38, the vial 14 is displaced by the star wheel 38 in the direction of arrow 44 towards the inspection start wheel 36. The vial 14 is then engaged by the inspection star wheel 36 and disengaged from the start wheel 38 and is displaced by the inspection star wheel 36 in the direction of arrow 46. While engaged by the inspection star wheel 36, the vial 14 is displaced through or below the inspection station 34 during which time the inspection station 34 measures the gap 16 between the vial 14 and stopper 12.

If, based upon the gap measurements obtained and analyzed by the inspection station 24, the gap 16 is determined to be within a predetermined acceptable range, the vial 14 is disengaged from the inspection star wheel 36 so as to exit the system 10 through the out-feed 48 in the direction of arrows 58 and 50. The out-feed 48 may, for example, lead the vial to a capper station. If, based upon the gap measurements obtained and analyzed by the inspection station 24, the gap 16 is determined to be outside of a predetermined acceptable range, the vial 14 is disengaged from the inspection star wheel 36 so as to displace the vial 14 in the direction of arrow 56 along a reject path to a reject turn table or other holding location, not shown.

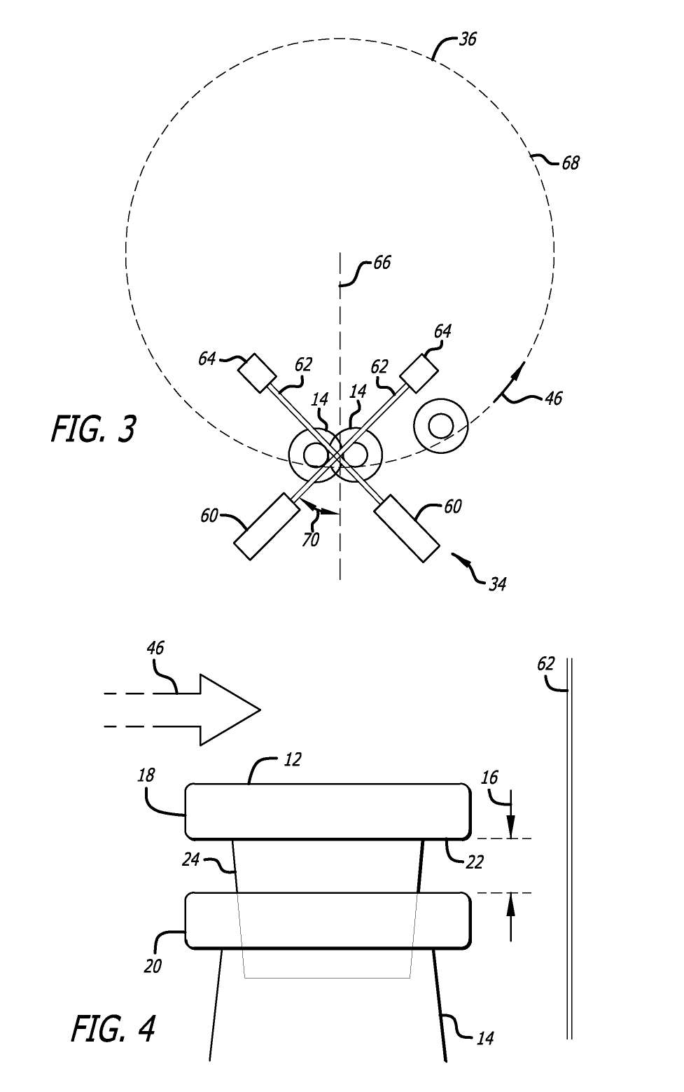

Turning next to the configuration and related operation of the inspection station 34, as shown in FIG. 3 the inspection station 34 employs a laser 60, emitting a light along path 62 that is received by a receiver 64. The inspection station 34 may employ one or more laser 60 and receiver 64 pairs, for example, in the embodiment shown in FIG. 3, the inspection station 34 employs two of the laser 60 and receiver 64 pairs positioned such that the light paths 62 of the two pairs of lasers 60 and receivers 64 cross one another to form a 90 degree angle. The laser 60 and receiver 64 pairs are further oriented such that their respective light paths 62 form an angle 70 of approximately 45 degrees with a line 66 that is substantially perpendicular to the product inspection path 68 of the vial 14 that is engaged by inspection star wheel 36 rotating in the direction of arrow 46. For the sake of clarity, FIG. 3 shows a single vial 14 as it is displaced along the product inspection path 68 relative to the laser 60 and receiver 64 pairs of the inspection station 34.

The laser 60 may, for example, be a laser micrometer that employs a multi-wavelength laser having a linearity of approximately plus-or-minus 0.1 percent. The receiver 64 may, for example, employ an integrated L-CCD, linearized-charged coupled device or other suitable digital imaging devices. The laser 60 and receiver 64 may, for example, have a sampling rate of 980 microseconds, a repeatability of 5 micrometers (0.02 Mil), a resolution of 5 micrometers (0.02 Mil), and employ an I-DSP parallel computing chip. Suitable laser micrometers are produced by a variety of manufacturers including the Keyence Corporation, Osaka, Japan.

FIG. 4 is a simplified diagram showing the light path 62 of the laser 60 relative to the vial 14 and stopper 12 as the vial 14 is displaced through the inspection station 34. The laser 60 and/or the receiver 64 are not shown. As shown, the light path 62 forms a defined vertical plane. As the vial 14 and stopper 12 are displaced in the direction 46 toward the stationary light path 62, the portions of the light path 62 are disrupted or interfered by the flange 18 and the neck 24 of the stopper 12 and by the vial 14. The gap 16 is measured based upon the portion of the light path 62 that is not disrupted by the flange 18 of the stopper 12 and the vial 14.

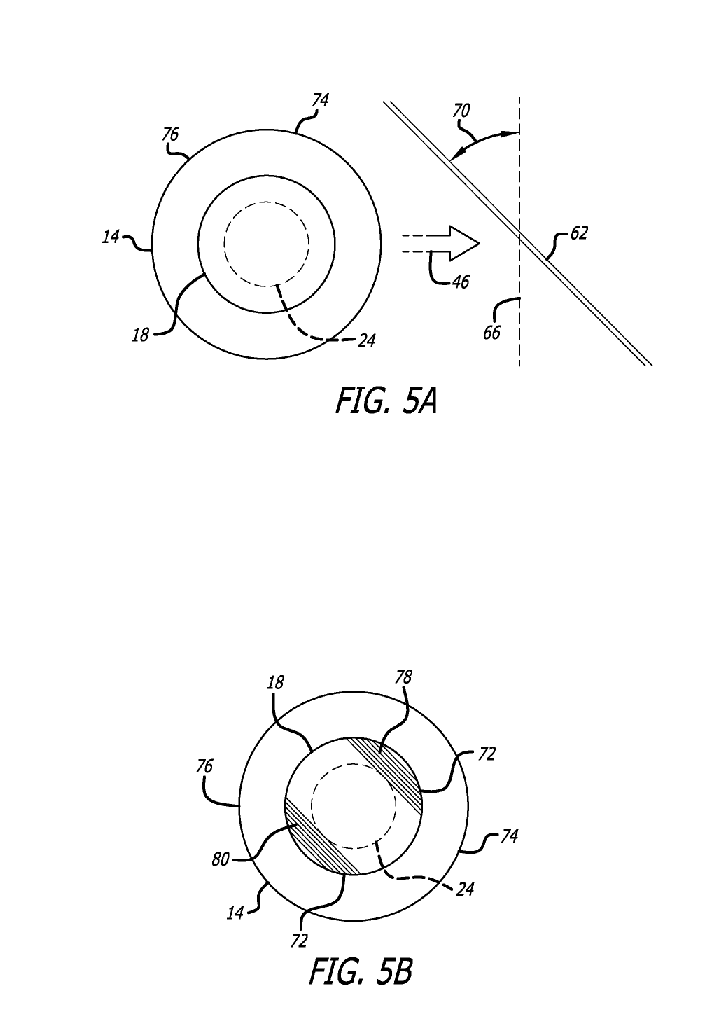

FIGS. 5A and 5B show an example of the scan patterns 70 obtained from the inspection station 34 as the vial 14 is displaced through a single light path 62. As the vial 14 travels in the direction of arrow 46 through the inspection station 34, multiple scans take place, represented by the series of lines of a scan pattern 72. It is noted that an individual scan pattern may, for example, comprise of 10 to 20 individual scans or, in some embodiments 1 to 100 individual scans. As a leading side 74 of the vial 14 passes through the light path 62 measurements are obtained in a first region 78. As a trailing side 76 of the vial proceeds through the light path 62 measurements are obtained in a second region 80. The laser 60 and receiver 64 obtain numerous measurements through the light path 62. From these individual scan patterns, the largest measured values will be captured and used for gap pass/fail determination.

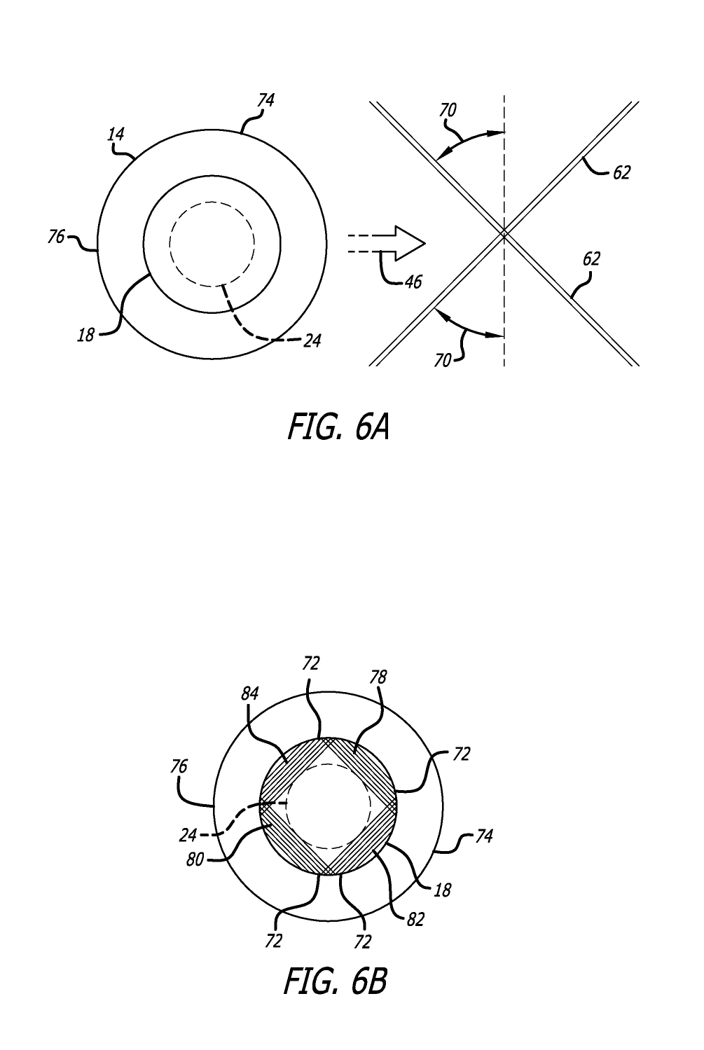

FIGS. 6A and 6B show an example of the scan patterns 70 obtained from the inspection station 34 as the vial 14 is displaced through two light paths 62. As the vial 14 travels in the direction of arrow 46 through the inspection station 34, the laser 60 and receiver 64 pairs obtain numerous measurements through the light path 62. As a leading side 74 of the vial 14 passes through the light path 62 measurements are obtained in the first region 78 and a third region 82. As a trailing side 76 of the vial proceeds through the light path 62 measurements are obtained in the second region 80 and a fourth region 84.

As will be noted, when two laser 60 and receiver 64 pairs are employed in the inspection system 34, four approximately equally dispersed regions 78, 80, 82, and 84 around the neck 24 of the stopper 12 are measured. It will be appreciated that increasing the number of laser 60 and receiver 64 pairs, for example from two pair, as shown in FIGS. 3 and 6A and 6B, to three or four pairs will further increase the number of regions scanned and thereby the uniformity of the measurements around the neck 24 of the stopper 12.

As also shown in FIGS. 5B and 6B, the scan patterns 72 of the regions 78, 80, 82, and 84 do not include scans of the outermost circumference or portion of the flange 18 of the stopper 12 and, correspondently, do not include scans of the outer most circumference or portion of the rim 20 of the vial 14. Stated alternatively, the scan patterns 72 do not sample to the outer most extremes of the flange 18 of the stopper 12 or the rim 20 of the vial 14. As shown in FIGS. 1A-1C and 4, an outer portion of the rim 20 of the vial 14 and the flange 18 of the stopper 12 may employ rounded, beveled, or otherwise non-planar transitions from a substantially horizontal plane to a substantially vertical plane. If these rounded edges are included within the scan pattern 72, the measurements obtained approximate these edges may be greater than the proximate interior measurements and thereby adversely result in incorrect pass/fail determinations. For example, inclusion of these rounded edges may result in measurements and subsequent determination of gaps 16 that are greater or larger than is actually the circumstance. Accordingly, inclusion of the rounded edge portions may result in artificially high measurements of gaps 16 that are outside of the acceptable gap 16 threshold, thereby unnecessarily increasing the packaging loss of the product being packaged. It will be appreciated that as a greater number of laser 60 and receiver 64 pairs are employed in the inspection station 34, the angle formed by intersecting light paths 62 of the respective pairs will decrease.

In certain embodiments, for example, in applications in which the system 10 is utilized to inspect irregularly shaped and/or actuated vessels or closures, it may be desirable to position the laser 60 and receiver 64 pairs in a non-uniform or irregularly spaced orientation.

In certain other embodiments, the inspection system 10 according to the present invention employs an inspection system having the above described laser 60 and receiver 64 pairs in combination with a laser line scanner. The laser line scanner is configured to scan a top surface of the stopper 12 to determine a height of the stopper 12 within the vial 14. The top mounted laser line scanner provides a method to indirectly measure the gap 16 completely around a diameter of the vial 12. The line scanner is mounted with the laser pointed down and the line scan perpendicular to the direction of the travel of the vial 12. As the vial passes through the laser line, the device provides hundreds of relative height measurements across the top surface of the stopper. This is performed simultaneously with the scans performed by the laser 60 and receiver 64 pairs described above. Combined with the known gap measurements from the aforementioned scans performed by the laser 60 and receiver 64 pairs, additional gap values are extrapolated around the full diameter of the vial 12. This provides a more detailed analysis of the entire gap 16. Suitable laser line scanners are available from numerous sources including Micro-Epsilon, Raleigh, N.C., and Schmitt Industries, Portland, Oreg., under the Acuity product name.

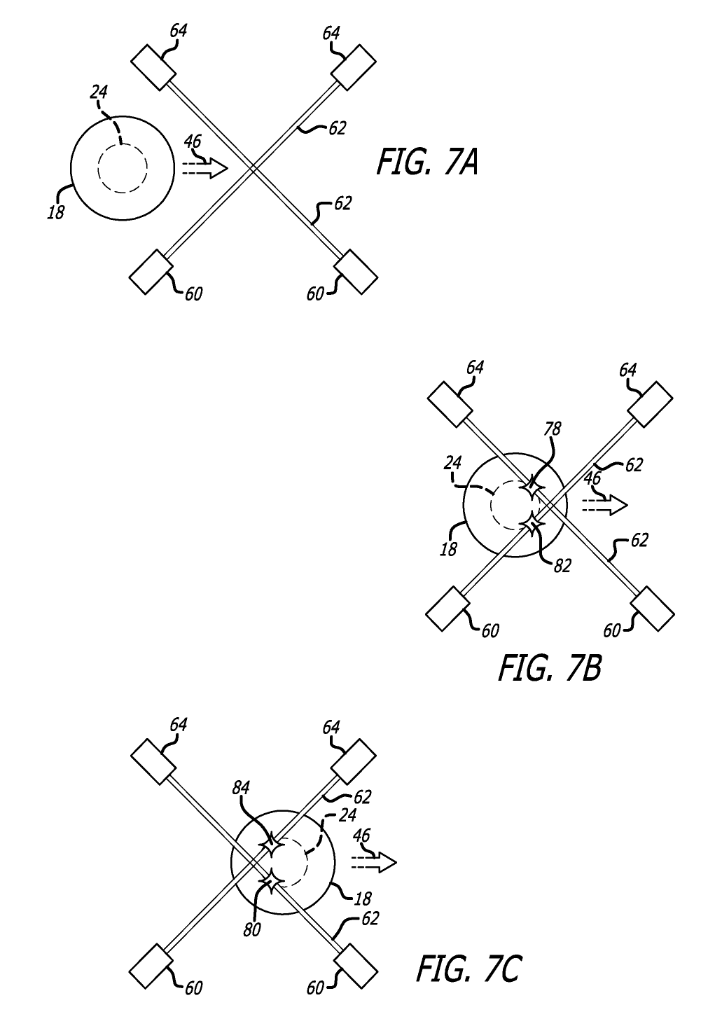

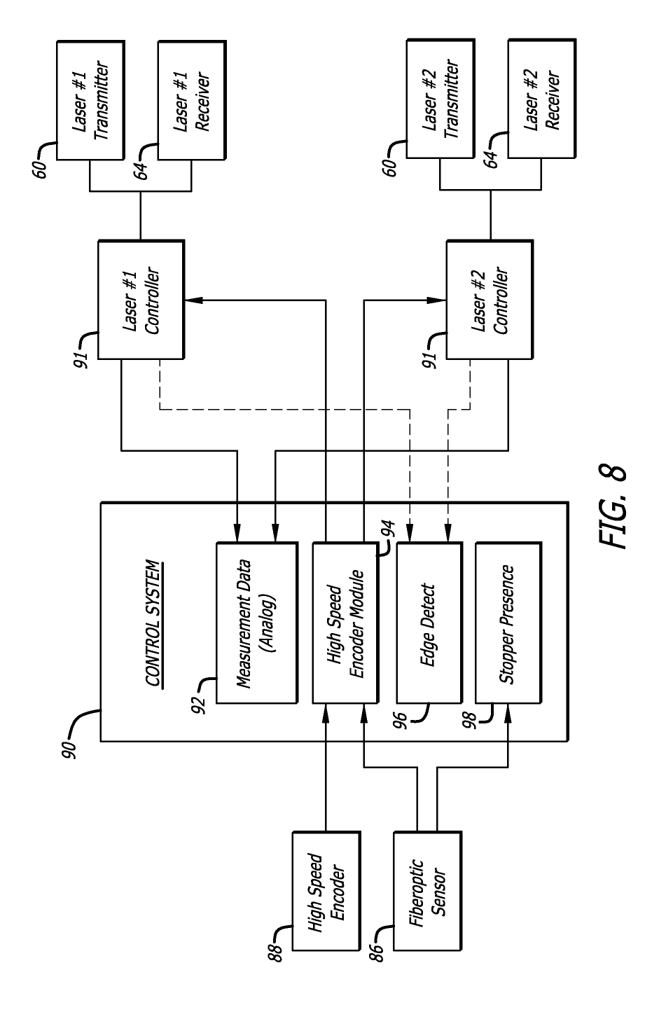

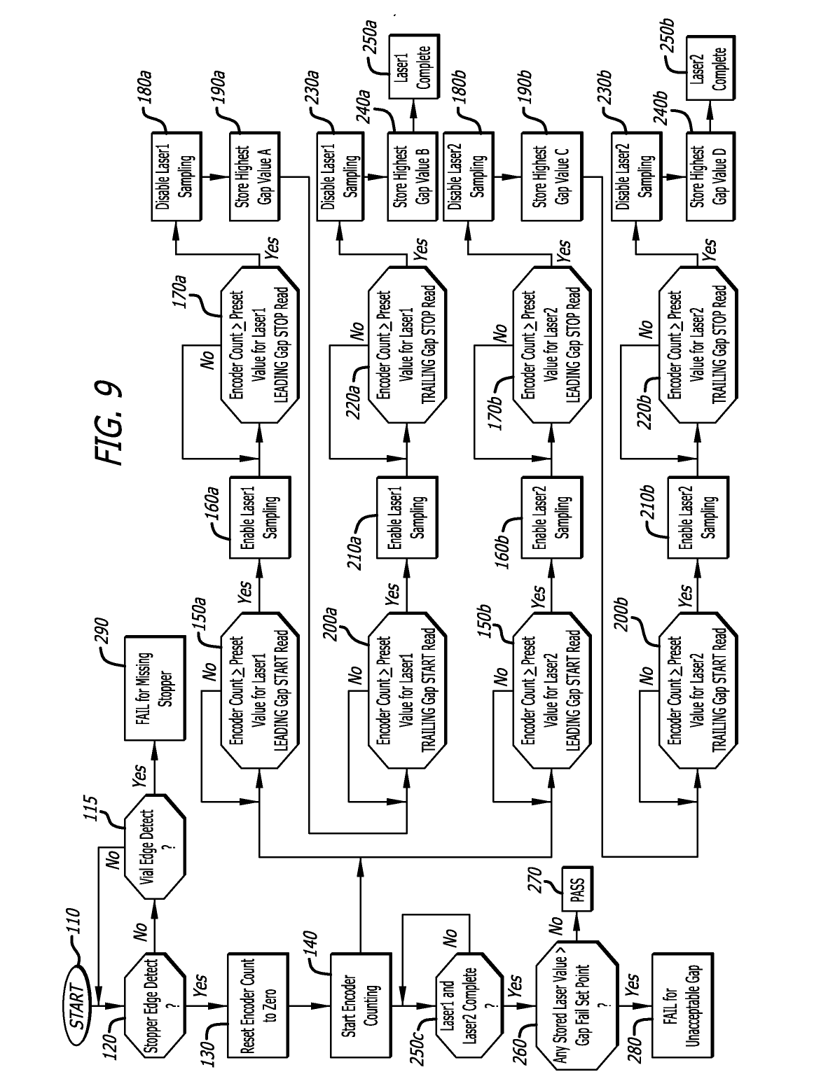

The detection system 10 according to one embodiment of the present invention is described in greater detail below through description of certain steps of its operation and with reference to FIGS. 7A-7C, 8, and 9. FIGS. 7A-7C show the progression of a vial 14 through an inspection station 34. FIG. 8 is a simplified diagram showing the relationship of various components of the inspection station 34, and FIG. 9 is a flow diagram showing a generalized logic flow diagram of the system 10.

As a starting point, once the vial 14 is engaged by the inspection star wheel 36, the vial is displaced in the direction of arrow 46 towards the inspection station 34. See box 110 of FIG. 9. As the vial 12 approaches the inspection station 34, a sensor 86, for example, an image or photo or optical sensor detects the leading side 74 of the stopper 12. See box 120 of FIG. 9. At this point, a reference for an encoder 88 associated with the inspection star wheel 36, for example, a high speed position tracking encoder, is set or otherwise designated to be zero or another unique identifier. See box 130 of FIG. 9. As the vial 12 continues to move through the inspection station 34, the encoder 88 will increment with reference to the predetermined reference or start point. See box 140 of FIG. 9. When the encoder 88 of the inspection star wheel 36, and thereby the vial 14 engaged with the inspection star wheel 36, reaches a predetermined Start Read 1 position, a high speed count module 94 of the control system 90 triggers the lasers 60 and the receivers 64 to start scanning the vial 14 at regions 78 and 82. See boxes 150a, 150b, 160a, and 160b of FIG. 9.

Based upon the scans obtained by the lasers 60 and the receivers 64 as the vial 14 moves through the light paths 62, an edge detection module 96 of the control system 90 will detect edge transitions created by the lower surface 22 of the flange 18 of the stopper 12 and the rim 20 of the vial 14. See box 115 of FIG. 9. The lasers 60 and associated receivers 64 will also continuously measure the gap 16 and will store the greatest measured value obtained during the individual scan patterns 72 in the measurement module 92 of the control system 90. As the vial 14 continues to move through the light path 62, an End Read 1 position is sensed by the encoder 88. The End Read 1 position is the point where the leading side 74 of the neck 24 of the stopper 12 enters the light path 62. No measurements are obtained once the neck 24 of the stopper 12 is within the light path 62. The measured gaps 16 are evaluated and stored by the control system 90. See boxes 170a, 170b, 180a, 180b, 190a, and 190b of FIG. 9.

As the vial 14 continues to move through the light path 62, the vial 14 reaches the Start Read 2 position. See boxes 200a and 200b of FIG. 9. The Start Read 2 position is the position in which the trailing side 76 of the neck 24 of the stopper 12 passes through the light path 62. At the Start Read 2 position the high speed count module 94 triggers the lasers 60 and associated receivers 64 to again start continuously measuring the gap 16. See boxes 210a and 210b of FIG. 9. As the vial continues to move through the light path 62, the End Read 2 position is reached at which point the high speed count module 94 will then trigger the lasers 60 and associated receivers 64 to stop scanning and will store the greatest measured values obtained during the individual scan patterns 72 in the measurement module 92 of the control system 90. No further measurements are obtained. See boxes 220a, 220b, 230a, 230b, 240a, 240b, 250a, 250b and 250c of FIG. 9.

The Start Read 1 and 2 positions and the End Read 1 and 2 positions are predetermined values entered into the control system 90 during inspection recipe selection. As will be appreciated, these read positions are defined by the specifications of the vials 14 being packaged. For example, a recipe for a 2 milliliter vial from a first manufacturer may have a different diameter or rim width than a 2 milliliter vial obtained from a different manufacturer or from a 4 milliliter vial. Once the proper recipe has been selected, the measurement trigger or read position point data is loaded to the high speed counter module 94.

The maximum measured values for gaps 16 from each scan pattern 72 obtained from each region 78, 80, 82, 84, are compared to predetermined pass/fail thresholds and the control system 90 will accept or reject the vial 14 accordingly. See boxes 260, 270, and 280 of FIG. 9. The accept and reject status of the vial 14 is loaded into a part tracking shift register of the control system 90 to be used for vial disposition at an accept and reject station of the section system 10.

If during the inspection process, the sensor 86 fails to detect a stopper 12, but edge detection module 94 determines the presence of an edge, a stopper presence module 98 of the control system 90 will determine that the vial 14 is missing a stopper. See boxes 290 of FIG. 9. The vial 14 is designated as reject—no stopper, and will be tracked and offloaded to the reject area.

If an excessive number of rejects is detected, the control system 90 will generate a fault, cycle stop, and display a message indicating ‘Excessive Rejects’.

During the scanning process, the control system 90 monitors the output of the edge check module 96 in order to verify proper operation of the lasers 60 and the receivers 64. If, when the lasers 60 and the receivers 64 are triggered to scan, the edge check module 96 output does not transition, the control system 90 will generate a fault, cycle stop, and, for example, display a message indicating laser measurement failure.

It will be recognized that the consistent positioning of the vial 14 within the inspection start wheel 36 is a significant factor in maintaining the accuracy and repeatability of the gap 16 measurements obtained by the system 10. Accordingly, in certain embodiments of the present invention, the inspection star wheel 36 employs a “v” shape or a partial multisided geometric shape having planar side that taper to a common point or plane, such as a partial hexagon shaped indentions. Such recesses or indentations function to more easily position each vial 14 into the same relative position within the indentions of the wheel 36. In certain embodiments, it may be desirable to secure the vial within the indention of the inspection star wheel 36 by engaging the vial 14 with suction or a spring biased retainer.

In certain embodiments of the present invention, the inspection station 34 of the detection system 10 employs a laser controller 91 that is configured to control certain features and functionality of the laser 60 and the receivers 64.

In certain embodiments of the present invention, the control system 90 of the detection system 10 employs a programmable logic controller, PLC or an independent, printed circuit board controller.

The detection system 10 of the present invention is operable to provide the following advantageous of known vision-based detection systems. The detection system 10 provides increased accuracy, having a standard deviation of 0.03 millimeters as compared to a standard deviation of approximately 0.09 millimeters, approximately one-third the standard deviation of vision/based system.

The detection system 10 according to the present invention is advantageous over known vision-based inspection systems at least for the reason that the detection system 10 provides improved repeatability and accuracy. Therefore, false rejects are minimized and greater packaging efficiency is achieved. The detection system 10 is also easier to maintain than vision-based systems because the laser is less affected by outside variables such as lighting, product color variation, etc. The detection system 10 provides for simpler system set-up because vision-based systems require specific programming for every product variance. Since the detection system 10 utilizes direct measurement form lasers, the programmed solution is basically “off-the-shelf” and more robust.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

1. A detection system comprising:
at least one light path defined by a laser and a receiver; and
a product inspection path that crosses the at least one light path.

2. The system of claim 1 wherein the at least one light path comprises two light paths defined by two pairs of the laser and the receiver.

3. The system of claim 1 wherein the receiver comprises a linearized charged couple device.

4. The system of claim 1 wherein the light path comprises a multi-wavelength light.

5. The system of claim 1 wherein the receiver is configured to detect an edge formed within the light path.

6. The system of claim 1 further comprising an image sensor configured to detect a portion of a product disposed on the product path.

7. The system of claim 1 further comprising a controller configured to initiate and terminate scanning of a product disposed on the product path.

8. The system of claim 7 further comprising an encoder associated with the product inspection path and in data communication with the controller.

9. A method for inspecting package closures comprising the steps of:
transposing a product along a product inspection path;
scanning a leading edge of the product with a linerarized light;
receiving a portion of the linerarized light;
determining a dimension of the product based upon the step of scanning a leading edge;
scanning a trailing edge of the product with the linerarized light;
receiving a portion of the linerarized light; and
determining a dimension of the product based upon the step of scanning a trailing edge of the product.

10. The method of claim 9 wherein the step of transposing a product along a product inspection path comprises transposing a vial having a stopper inserted therein.

11. The method of claim 9 wherein the step of scanning a leading edge of the product with a linerarized light comprises scanning the leading edge of the product with a multi-wavelength light.

12. The method of claim 9 wherein the step of scanning a leading edge of the product with a linerarized light comprises scanning the leading edge of the product with a laser beam.

13. The method of claim 9 wherein the step of scanning a leading edge of the product with a linerarized light comprises scanning the leading edge of the product with a light having a light path that forms an angle of approximately 45 degrees with a direction in which the product is being transposed.

14. The method of claim 9 further comprising scanning a leading edge of the product with a linerarized light comprises scanning the leading edge of the product with two different sources of linerarized light.

15. A package closure inspection system comprising:
a product inspection wheel defining a portion of a product inspection path;
a sensor configured to sense a portion of a leading edge of a product transposed by the product inspection wheel;
at least two light paths, each of the at least two light paths defined by a laser and a receiver and crossing the product inspection path.

16. The system of claim 15 wherein the product inspection wheel comprises indentions having planar sides tapered to a common point.

17. The system of claim 15 wherein the product inspection wheel is associated with an encoder.

18. The system of claim 15 wherein the sensor comprises an image sensor.

19. The system of claim 15 wherein the two light paths each define an angle of approximately 45 degrees with the product inspection path.

20. The system of claim 15 wherein the two light paths form an angle with one another of approximately 90 degrees.
